(19) United States
(12) Patent Application Publication
(10) Pub. No.: US 2016/0117397 A1
(43) Pub. Date: Apr. 28, 2016

(54) SYSTEM AND METHOD FOR IDENTIFYING EXPERTS ON SOCIAL MEDIA

(71) Applicant: THE GOVERNING COUNCIL OF THE UNIVERSITY OF TORONTO, Toronto (CA)

(72) Inventors: Nilesh BANSAL, Toronto (CA); Nick KOUDAS, Toronto (CA)

(21) Appl. No.: 14/522,803

(22) Filed: Oct. 24, 2014

(51) Int. Cl. G06F 17/30; G06Q 50/00

(52) U.S. Cl. CPC G06F 17/30867; G06F 17/3053; G06Q 50/01

(57) ABSTRACT

A system and method for identifying experts on social media and more specifically to systems and methods for identifying experts, topics and followers in social media networks that may be used to engage or track a wide and relevant audience for message targeting.

### TECHNICAL FIELD

The following relates generally to a system and method for identifying experts on social media and more specifically to systems and methods for identifying experts, topics and followers in social media networks that may be used to engage or track a wide and relevant audience for message targeting.

### BACKGROUND

Social media has transformed the way we interact online as individuals and consumers. At the same time, it is transforming the way businesses aim to interact with their customers and fans online. Before social media became mainstream, online marketers and advertisers resorted to the collection of behavioral online information regarding individuals to target their messages. Individuals were primarily targeted based on the topical focus of the sites they visited. For example, sports news sites might display advertising related to the perceived interests of sports fans. The general interests of sports fans would be derived based on third party market research (e.g., males aged 25-35 with interest in sports are also interested in certain types of movies or specific male grooming products).

In the early stages of the social web, bloggers on particular topics with wide followings were identified to endorse or sponsor specific products. At the same time, bloggers started serving advertisements on their blog real estate.

Social media is transforming the way marketers and advertisers spend their budgets. Novel ways to market online are gaining traction both from an academic as well as a practical point of view. In particular, influencer-based targeting in social media has emerged as a very popular way to market on social platforms (such as Twitter and Facebook). Individuals are identified as online experts in particular topics; they are either incentivized to participate in sponsored advertising by spreading the messages to their followers or the platforms automatically insert sponsored messages in their activity streams (as in the case of Twitter/Facebook advertising). Further, they may be targeted with relevant content such that they organically share it with their followers. The goal is to increase brand awareness, by increasing the number of impressions (e.g., how many followers see a particular message) and click-throughs to particular campaign (how many click on the link embedded in the message) with the ultimate goal to track conversions (how many end up purchasing a product).

As an example, with more than 250 million users, Twitter has emerged as a prominent marketing and advertising vehicle in addition to being a prominent social communications platform.

### SUMMARY

In one aspect a system for identifying one or more experts of a topic on a social network is provided, the system comprising a server in communication over a network with a social network, the server comprising: (a) a user interface unit configured to obtain a topical query representing the topic; (b) an obtaining unit configured to obtain social network data from the social network, the social network data comprising one or more topical lists and a social graph representing user relationships in the social network, each topical list identifying one or more users; (c) a tokenizing unit configured to: (i) tokenize titles of the topical lists and lexically group the tokens into token groupings; and (ii) tokenize the topical query to determine at least one token grouping to which the topical query corresponds; and (d) a processing unit configured to: (i) generate, for each user, a topic signature vector comprising topic signature vector eLements corresponding to the token groupings for which the user is identified in the corresponding topical lists; (ii) generate for each topic signature vector element an occurrence count representing the number of times each of the token groupings is identified for the user; (iii) rank the users by their occurrence counts for the at least one token groupings corresponding to the topical query; and (iv) return a selected set of the ranked users as experts in the topic.

In another aspect, a computer network implemented method for identifying one or more experts of a topic on a social network is provided, the method comprising: (a) obtaining a topical query representing the topic; (b) obtaining soda network data from the social network, the social network data comprising one or more topical lists and a social graph representing user relationships in the social network, each topical list identifying one or more users; (c) tokenizing titles of the topical lists and lexically grouping the tokens into token groupings; (d) tokenizing the topical query to determine at least one token grouping to which the topical query corresponds; (e) generating, by a processing unit comprising one or more processors, for each user, a topic signature vector comprising topic signature vector elements corresponding to the token groupings for which the user is identified in the corresponding topical lists; (f) generating, by the processing unit, for each topic signature vector element an occurrence count representing the number of times each of the token groupings is identified for the user; (g) ranking the users by theft occurrence counts for the at least one token groupings corresponding to the topical query; and (h) returning a selected set of the ranked users as experts in the topic.

### BRIEF DESCRIPTION OF THE DRAWINGS

The features of the invention will become more apparent in the following detailed description in which reference is made to the appended drawings wherein:

FIG. 1 is a block diagram of a system for identifying experts on social media;

FIG. 2 is a flowchart illustrating the process of creating a topic signature;

FIG. 3 illustrates a user interface for accessing the system;

FIG. 4 illustrates a user interface for accessing the system;

FIG. 5 illustrates a user interface for accessing the system;

FIG. 6 is a sample Twitter user and topic graph;

FIG. 7 is a graph illustrating the potential effect of random sampling on aspects of the system;

FIG. 8 is a graph illustrating the potential effect of random sampling on aspects of the system;

FIG. 9 is a graph illustrating the potential effect of random sampling on aspects of the system;

FIG. 10 is a graph illustrating the potential effect of random sampling on aspect of the system; and

FIG. 11 is a graph illustrating the potential effect of random sampling on the system.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It will also be appreciated that any module, unit, component, server, computer, terminal or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Any application or module herein described may be implemented using computer readable/executable instructions that may be stored or otherwise held by such computer readable media and executed by the one or more processors.

Advertising and marketing on Twitter involves two crucial steps. First, being able to identify who are the “experts” on any topic on the platform and second, being able to identify sets of users with active “interest” on a particular topic. In the context of Twitter, an expert in a particular topic is represented as an account (user) that primarily produces and shares content related to that topic and has a wide following that actively engages with the produced content (sharing, re-tweeting, etc.). A user may demonstrate interest in a particular topic if, for example the user follows a number of experts in the topic and engages with the content they produce.

A need exists to be able to identify experts on any given topic and analytical functions on the set of experts' accounts on a specific topic, such as what other topics they are experts in, what conversations they participate in, and what types of content they share online. A further need exists to identify other users (e.g., followers) that are likely to be interested in a given topic.

The following relates generally to systems and methods for identifying experts on social media. The system is configured to collect data on user interaction, communication and profile information to identify experts, topics and followers in social networks that may be used to engage or track a wide and relevant audience for marketing purposes. In another aspect, such information may be provided via a user interface to enable message targeting decisions.

Social networks like Google+, Facebook, Twitter, and Pinterest, have emerged as vehicles for marketing and branding. Marketers seeking to engage with, and advertise to, consumers may wish to identify a network of experts in and followers of given topics to whom to market specific content, as interests in a topic may correlate to sales of a given product or service. Without a loss of generality, Twitter will be used herein as an example of a social platform from which content may be collected to provide data regarding experts, topics and followers. The techniques described may be applied equally well to any other similar social platform. The terms “follower”, “marketer” and “social networks” are used herein illustratively and in a non-limiting manner. These terms could be substituted for appropriate parties as applicable to alternative implementations.

In another aspect, a system and method is provided for characterizing the expertise of particular social network users among a set of topics, including the generation of a topic signature for each user of a social network. A topic signature comprises a list of all topics of expertise of the user. Additionally, a system and method is provided to produce an aggregate signature. An aggregate signature comprises a list of topics in which a set of users has expertise. Both topic and aggregate signatures can be interpreted as a ranking of most relevant, for the purposes of reaching the largest audience, to least relevant topics.

Many social networks provide advertising platforms with tools for marketers. For example, in use, a marketer would utilize the Twitter advertising platform in one of the following three ways: Firstly, the advertiser provides a set of Twitter user handles, and Twitter targets advertisements to the followers of these accounts. Being able to identify sets of experts in any topic readily aids advertisers to identify the most relevant accounts to provide advertisements to while instigating a Twitter advertising campaign.

Secondly, the advertiser bids on a list of topics on Twitter. Twitter, using their own proprietary algorithms, identifies which users are interested in the topic and subsequently targets those users with messages “promoted” by the advertisers (inserting them in their tweet stream). By analyzing related topics for a topic of interest, advertisers can identify possibly cheaper topics to bid on. For example, if the price for ‘social marketing’ is too high, ‘seo’ as a related topic, which may have a relatively lower bid price may be used instead. The effectiveness of the campaign may be the same, due to the substantial overlap between the two.

Thirdly, the advertisers bid on search keywords (to target searches input to the Twitter search feature). Information on Twitter is temporal by nature and events evolve with time, thus the keywords used in searches evolve over time. When a keyword is used during a search query on Twitter for which an advertisement exists, the platform will display promoted messages (as advertising) along with the search results. Advertisers may wish to identify keywords related to a queried keyword at a given time.

However, the applicants have now determined that advertisers may also be interested in specific users that would be highly relevant as followers of a given user. These new followers should be highly interested in the topics for which the given user has expertise, since the followers desire to follow the given user's messages. Furthermore, the applicants have determined that advertisers may be well served by not just understanding who the experts are in relation to a given topic, but what other topics those users are interested in; for example, by identifying all experts in ‘cloud computing’ with interests in ‘photography’ or experts in ‘food and dining’ with interest in ‘movies’. Such sets of experts can be targets of novel engagement campaigns that attract attention by combining their area of expertise and their interests.

Various interactions between users and social networks such as Twitter result in data generation. Many social media networks record their interactions with their users. The system is configured to obtain interaction data via various sources and/or connectors. The social networks collect and record such data in logs stored on social network nodes or a network-accessable server. A social network may provide access to data collected on user interactions. For example, Twitter provides a Gardenhose streaming API which may be used to access messages and user profile information. Thus, Twitter activity may be stored in files that may be automatically created and maintained by a given server or set of servers. In another aspect, Twitter may be accessed directly via network connection, such as the internet, and data may be crawled, scraped and indexed. Crawling and scraping may be performed using various techniques by employing varying levels of automation. The obtained data may be stored in a database for ready use by the system.

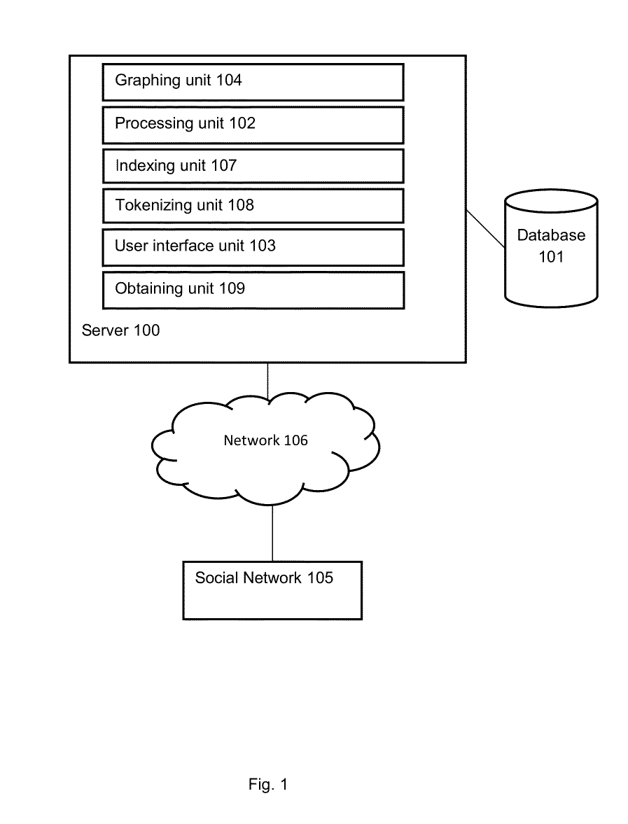

Referring now to FIG. 1, an exemplary system for identifying experts in a social network is shown. The system comprises network 106 connected elements including a server 100 linked to a database 101, and a social network 105. The network is in most implementations the internet. The server comprises an obtaining unit 109 for obtaining social network data, a tokenizing unit 108 for tokenizing social media messages, a processing unit 102 for processing the social media data to generate each user's topic signature and an aggregate signature for each topics, respectively, and an indexing unit 107 for interaction with the database to locally store the social network data. In further embodiments, the system may comprise a user interface unit 103. In yet an additional embodiment, a graphing unit 104 may be provided for generating or obtaining a social graph enabling a query for users that a given user is following. A representative embodiment contemplates the use of a processor which, it will be understood, could be implemented by a plurality of processors which could be distributed.

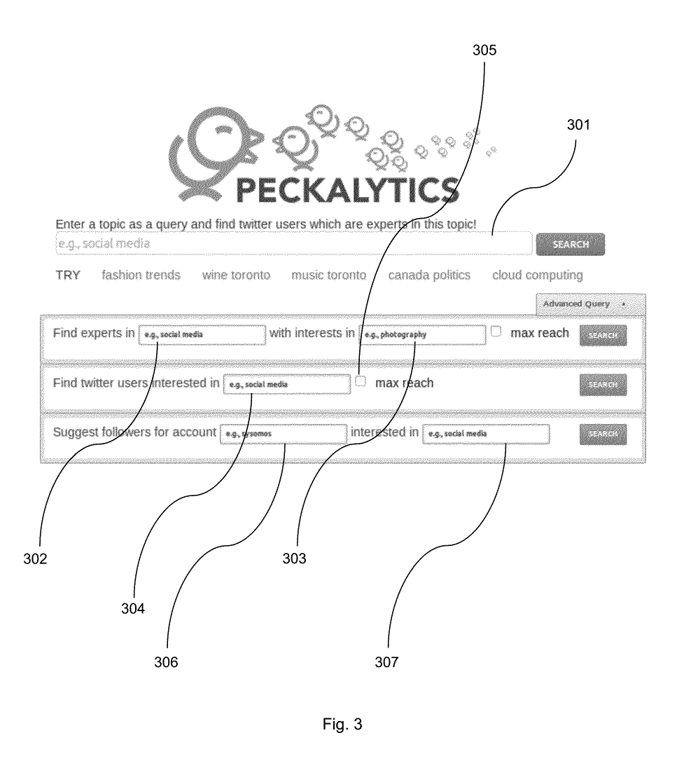

Referring now to FIG. 3, an exemplary user interface is shown. The user interface enables search for various social network experts. As previously described with reference to FIG. 1, the user interface enables interaction by a marketer (or similar person, organization or other end-user) with the system. A marketer may select from a plurality of commands in order to view social network expert data.

As shown in FIG. 3, the system may present a user with a plurality of options for identifying expert accounts. A search box 301 accepts topic queries with full boolean syntax. Alternatively, several advanced queries may be performed. The marketer may input a query to identify a user that is an expert in one topic 302 and displays an interest in another topic 303. The marketer may also find users interested in a given topic 304, and configure the search by selecting a checkbox to identify users that woud provide the widest reach 305. The option “max reach” 305, if selected, instructs the system to identify experts of topic A with interest in topic B, to collectively maximize the follower reach. This effectively means that the set of accounts reported of cardinality K collectively reach the maximum number of unique accounts (thus maximizing user impressions) among all possible subsets of expert accounts of size K, as will be discussed in more detail below. The user interface is further operable to accept the input of a particular user account 306 and a topic 307 to find followers of that user that have interest in a given topic. Any of the foregoing searches could also be limited to particular time intervals to pinpoint experts at relevant times.

To accomplish the foregoing, as mentioned above, the server comprises an obtaining unit 109 for obtaining social network data, a tokenizing unit 108 for tokenizing social media messages, a processing unit 102 for processing the social media data to generate each user's topic signature and an aggregate signature for each topics, respectively, and an indexing unit 107 for interaction with the database to locally store the social network data. In the case of the exemplary system that utilizes public Twitter data, obtaining unit 109 fetches 3 pieces of information from public Twitter data feed: the actual textual tweet contents from the public Gardenhose streaming API, the Twitter follower graph (who follows who), and the Twitter lists, as more fully set forth below.

The tokenizing unit 108 tokenizes the Twitter lists to produce topics and associates the topics to the users of the lists. The processing unit 102 uses the output association (of user to topics) from tokenizing unit 108 to instruct indexing unit 107 to stores it as a fast accessible index “IXD” in the database. The user interface unit 103 can use index “IXD” to process the topic query “q” to return the list of experts “E” as associated to the topics by tokenizing unit 108.

“IXD” supports this by storing (1) the inverted index from topics to a collection of users who belong to a Twitter list associated with the topic, and (2) total number of topic lists a given user belongs to. Using “IXD”, one can compute, given a specific topic and a specified user, the number of times the user is listed in a Twitter list associated with the specified topic (represented as “frequency count” or “occurrence count”). The inverted index is used to compute the set of all experts “E” associated with “q” by finding set intersection of index associated with each topic “t” present in the query “q”. The experts in “E” can be ranked for display using user interface unit 103 by using the frequency count as described above.

To return a list of related topics to “q”, user interface unit 103 will consult “IXD” to lookup all other topics for all users from “E”, call this set of all topics “A”. From “A”, a list of top ranked topics is presented to the user using some scoring function (frequency count, or tf.idf)

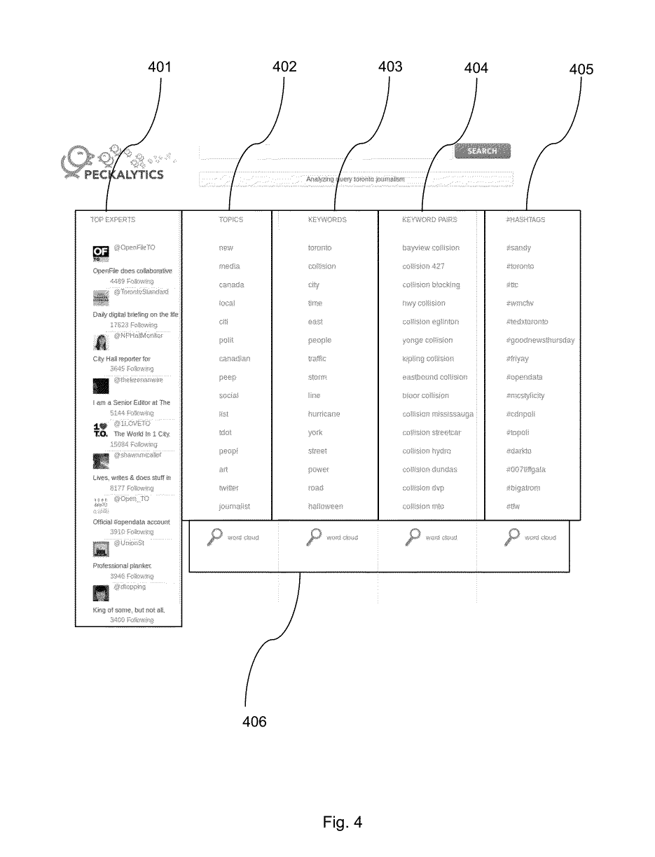

Referring now to FIG. 4, upon issuing a topic query, a plurality of expert accounts are retrieved and displayed 401 along with corresponding profile information. This can be accomplished by use of topic signature generation, which is described more fully below. Analytics on these accounts are also provided, which as shown include topics associated with the query topic in the topic signatures of these users 402, keywords used frequently in the recent messages of these users 403, keyword pairs resulting from a frequency analysis of the keyword associations between keywords in messages 404, as well as hashtags 405 which represent frequent hashtags in the recent messages of the accounts identified. For each such analysis function a visual word cloud 406 may be provided to study the words identified and their associated frequency via suitable font sizing. FIG. 4 illustrates how one can infer what topics they are also experts in (402), what type of conversations they participate in and share online (403, 404 and 405).

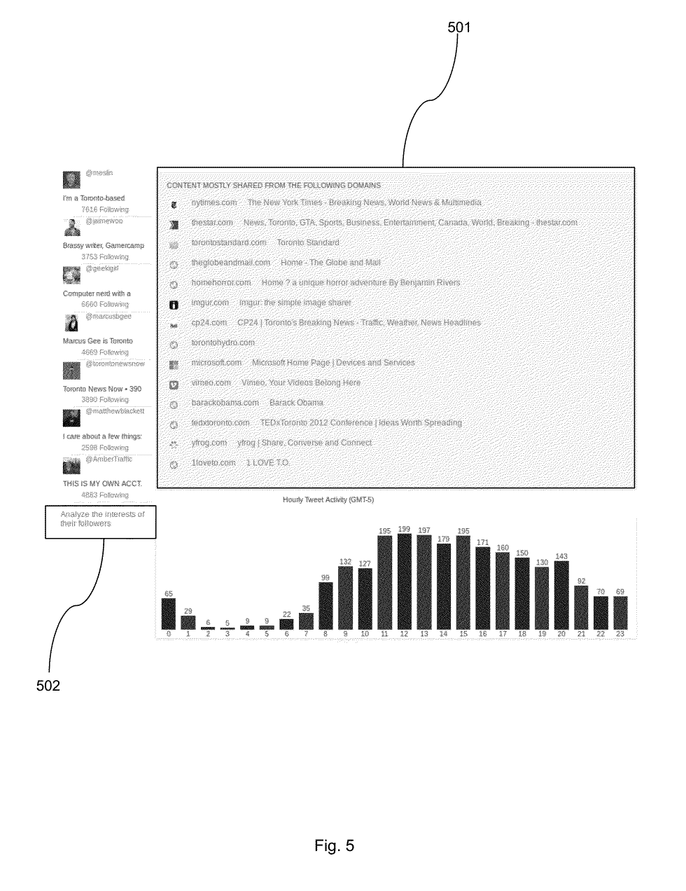

Referring now to FIG. 5, all domains from which content is frequently shared (in the form of URL links) via the messages of these users are shown 501. Additionally, a user may select the option to ‘Analyze the interests of their followers’ 502 and the system may automatically conduct the same analysis but this time taking into account collective followers of these accounts. This provides a mechanism for identifying the interests and analyzing the ‘audience’ of any expert group on Twitter. Preferably in this case the same type of output are returned to keep the same user experience. The means to provide the response to each of the foregoing types of queries will now be described.

Referring again to FIG. 1, the server 100 is in real time communication with the social network 105. The obtaining unit 109 obtains messages and corresponding metadata from the social network. Generally, message data and metadata can be obtained from APIs provided by social network, such as public APIs from Twitter, for example. For example, the obtaining unit 109 may utilize a streaming API (not shown) provided by the social network 105 to receive messages and associated metadata. The metadata may include the following: author name, author userid, set of followers and friends of the author, and lists the author has created. The database 101 may be integrated with the server, located in proximity of the server, or remotely from the server and accessible by network connection. Upon obtaining the message data and metadata, the obtaining unit 109 stores the data and metadata on the database. A suitable storage approach utilizes a compressed row format with each message being assigned a message identifier. As the data is stored, the indexing unit 107 is configured to create a table for each day for storage in the database. Each row in the table is a unique account identifier and a list of all message identifiers the account produced that day.

Relaxed transactional semantics may be run to increase throughput across multiple threads reading and writing the table. The tables for a selected time period may be stored on solid state drives (SSDs) for increased performance. The collection of tables keeping the association between account identifier and message identifiers may be stored in the database. The indexing unit may retrieve for any day, the identifiers of all messages produced that day for any set of accounts. The indexing unit may then provide the collection of all message identifiers to the database to retrieve the actual messages.

The obtaining unit is configured to collect account relationships, such as which users follow others directly. Certain social networks are configured to permit users to create lists containing a descriptive name (supplied by the creator) and a set of accounts associated to the list (supplied by the creator). For example, a list on “machine learning” may contain all accounts that are experts or very related to the topic of machine learning. The obtaining unit is configured to store the above mentioned data in the database 101.

The obtaining unit is further configured to receive information about which accounts follow others along with a set of metadata appended by the social network, associated with the accounts, for storage in the database. In an embodiment, this data may be represented by a graph that may be stored in a MYSQL instance. It will be appreciated that another relational database may be used as an alternative to MYSQL. The indexing unit is further configured to index this data. In embodiments, an Apache Lucene index may be used. It will be appreciated that another text search engine library may be used as an alternative to Apache Lucene. This data provides an expertise vector, or a set of all lists a given account is associated with. That information is then directed to Lucene to populate the index of topics as associated with the account. The index supports full Lucene query syntax including phrase queries and Boolean logic. At the same time, the social graph provides related information about user interests. For example, if a user follows someone with expertise in cooking, one may infer that the user has interest in cooking. Given all accounts followed by a given account, the union of both expertise vectors may produce an interest vector.

The server is configured to un-shorten multiple URLs. Since typically URLs in messages are shortened (using popular URL shortening sites like bit.ly or t.co) conducting analysis on the shared domains to provide insight into the source of the content is challenging as each URL has to be un-shortened (possibly multiple times). Thus the server efficiently un-shortens multiple URLs. Utilizing asynchronous 10 this process may be conducted for tens of thousands of URLs in parallel on a single thread, typically in a short time frame.

Given the receipt of some or a combination of the data mentioned above, the processing unit is able to generate useful information and analysis such as a topic signature for a given user, an aggregate signature for a group of users and techniques to automatically identify changes in the aggregate signatures over time for a given query.

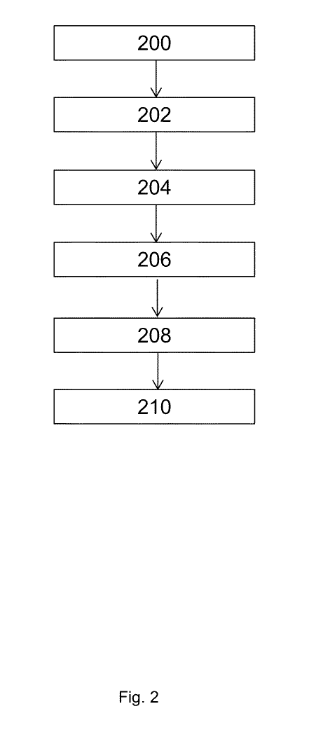

Referring now to FIG. 2, a flowchart showing the process for generating a topic signature is shown. At block 200, the obtaining unit obtains all or a subset of all lists on the social network. As lists are obtained, at block 202 the tokenizing unit is configured to tokenize the titles of the lists and, at block 204, remove stop words and other frequently appearing information as well as idioms that carry no information (e.g., ff, friends, etc.) from the list names. At block 206, a dictionary of similar words is then used to group together tokens that have the same meaning. A suitable technique utilizes WordNet, a large lexical database of English. Nouns, verbs, adjectives and adverbs are grouped into sets of cognitive synonyms (synsets), each expressing a distinct concept. It will be appreciated that alternative lexical databases may be used by the system for a similar purpose. At block 208, for each account, a vector of all tokens in the titles of all the lists of which the user is a member is assembled. Each token is accompanied by a number that expresses the occurrence count, namely, the processing unit calculates the number of times each token (grouping) was identified in a list title that of which the account is a member.

The vector may be referred to as the topic signature, assuming a total ordering on all topics (tokens) and assigning a value of zero to the occurrence count for a topic if the account is not associated with that topic at all. Assuming each token to be a unique dimension in a multi-dimensional space, the occurrence counts are normalized to produce the unit topic signature vector in [symbol] space. Thus, this vector represents the weight of the account being associated with a topic. The [symbol] space is used and hence, the length of the expertise vector is normalized to 1 using the manhattan norm. The union of all these vectors will result in a multi-dimensional space with each unique token corresponding to a dimension.

In an exemplary scenario, consider a user @john that is member of three Lists {toronto-dentist, dentists, music-toronto}. The set of tokens with occurrence counts for this user is {dentist(2), toronto(2), music(1)}. After normalization, the unit topic signature vector becomes

$$topics ( john ) = \frac{2}{5} \hat{d} entist + \frac{1}{5} \hat{m} usic + \frac{2}{5} \hat{t} oronto .$$

The vector above is of unit length in [symbol] space, with non-zero values across three dimensions and zero across all others.

Considering two more users in the same scenario: @henry belonging to lists {dentists, squash-london, music}, and @susan who is a member of lists {squash, music-london, squash-london}. After considering all the 3 users, a 5-dimensional topic space is produced:

$$( \begin{matrix} & dentist & music & london & squash & toronto \\ john & \frac{2}{5} & \frac{1}{5} & 0 & 0 & \frac{2}{5} \\ henry & \frac{1}{4} & \frac{1}{4} & \frac{1}{4} & \frac{1}{4} & 0 \\ susan & 0 & \frac{1}{5} & \frac{2}{5} & \frac{2}{5} & 0\end{matrix} )$$

The above matrix is a compact form notation of individually writing the vectors as

$$topics ( john ) = \frac{2}{5} \hat{d} entist + \frac{1}{5} \hat{m} usic + 0 \hat{l} ondon + 0 \hat{s} quash + \frac{2}{5} \hat{t} oronto ,$$

and so on.

The process of computing topic signatures for each user is linear in the number of users and the length of their topic signatures. In this example, the technique of extracting topic signatures is applied on messages from 240 million users and 15 million lists. Apache Lucene may be used for implementing the tokenizing unit and indexing unit to tokenize and index the lists.

The generated topic signature provide for fast response to a request for an expert list in response to a topic query. The index allows query with full boolean syntax, and is used to quickly return all users having certain topic associations. For example, in response to a query, the query is tokenized and processed lexically in similar manner to lists are processed as described in reference to FIG. 2. Users may be ranked by the occurrence count in their respective pre-normalized topic signature for the token grouping(s) corresponding to the querry, and a particular number of the highly ranked users may be returned as experts. It will be appreciated that obtaining from the database a list of the users related to the query can be made relatively quickly due to the intelligent approach to indexing taking at the time of storage.

To describe how the processing unit generates the aggregate signature, the following setting and notation will be used: Let the set of all users be denoted by U^{M}, which has cardinality M. Let uεU^{M} denote a unique user, with unit normalized topic signature vector topics(u). The vectors are derived from a multi-dimensional space S^{N} with N dimensions. The matrix representing signature vectors for all users will then have M×N entries. We denote this matrix as M^{SE}.

If sᵢ is a specific dimension in S^{N}, then the signature vector may be represented as follows where wᵢ represents length of the vector across dimension sᵢ, topics=w₁·ŝ₁+w₂·ŝ₂+ . . . +w_{N}·ŝ_{N}. The graphing unit generates a social graph, where the social graph spanning all users denoting follower relationships is represented by (U^{M}, E), where U^{M} is the set of nodes and E is the set of edges. Each user represents a node. Edges are follower relationships, i.e., if a user u follows another user v, then the directed edge from u to v will be part of the set of edges E. Formally, u, vεU^{M}, follows(u, v)=true [symbol] (u, v)εE. Let q represent a keyword query such as, “hurricane sandy” or “pepsi”; the query may permit more complex queries that include boolean operators such as, “elections AND (“barack obama” OR “mitt romney”)” as well. Let R represent the set of message results after evaluating the query against the content of all raw messages obtained by the obtaining unit from the social network and stored in the database. If the search has a time restriction t denoting that only results within the time interval t are of interest, the set of results is Rₜ. Each entry rεRₜ is a message such that matches(q, r)=true meaning that the query evaluates to true on message r and postₜᵢₘₑ₍ᵣ₎εt, namely that the message was posted within the time interval of interest t. Let Aₜ denote the set of all unique authors (users) in Rₜ, i.e., set of authors of all messages rεRₜ. uεAₜ [symbol] ∃rεRₜ:author(r)=u.

As M^{SE} can potentially consists of a large number of entries, it is desirable to produce a concise summary of M^{SE} as aggregate signature. This can be done by first computing the relevant rank of each user in the set U^{M} using the social graph and network ranking algorithms such as PageRank. Then, conditional probability can be utilized to aggregate the topics. This process is mathematically the following: Pr(sᵢ)=Σⱼ Pr(sᵢ|uj)*Pr(uⱼ) for expertise sᵢ and user uⱼ where Pr(sᵢ) denotes the probability of sᵢ over the appropriate sample space.

The aggregate signature may be used for two main purposes, namely, a) to obtain a concise view of the topics associated with the messages of interest (denoted by the query q above). This is done by aggregating the expertise vector of all authors who have authored one of the messages of interest. and b) to rank those topics based on their potential for dissemination within the social network. This is done by summing over the users and their topics/expertise using conditional probability. The utility of such an aggregate signature may be to gain insight on what topics a marketer may associate with q in order to increase the reach and dissemination of messages related to q in the Twitter network, via sharing through re-posting messages from those accounts sending messages about q.

The processing unit may alternatively generate the aggregate signature of all followers of a particular account (instead of author group for a query). For example, a marketer may be interested in understanding who is talking about the brand Pepsi on Twitter and the aggregate of topics associated with that group. This information may be used to create better advertising content for this group, e.g., if many users are associated with travel, then a good strategy could be to create marketing messages incorporating travel as a theme. That way one aims to capture the attention of the group in multiple ways and increases engagement and content sharing.

Thus, in order to maximize the spread of marketing content to a relevant group it is desirable to direct resources toward users who can spread the content (e.g., by re-tweeting or resharing the message). Hence, when constructing the aggregate signature not every member of Aₜ is considered with an equal weight. The aggregate signature aggrsig(q, t) (or correspondingly aggrsig(Aₜ)) is computed by taking in account the ability of a user to spread a message.

Given a query q, time interval t, and its associated set of authors Aₜ from result set Rₜ the processing unit generates the aggregate signature aggrsig(q, t) taking into account the potential reach of each author in Aₜ. Having retrieved all messages Rₜ with respect to the query q of time interval t, the processing unit scans through all items in Rₜ to resolve the set of unique users from Rₜ as Aₜ. The processing unit is operable to generate the topic signatures for each user in Aₜ.

One strategy to produce aggregate signatures is to sum up the topic signatures retrieved and normalize them to unit length. However, this method fails to capture the relative importance of each user in disseminating a message to their followers with respect to the query q. Under this scheme all users are assumed equally important as far as the dissemination potential is concerned, which may not actually reflect reality. For example, the set Aₜ may contain several users with association in the topic of music but each with very few followers, and few users with association in the topic of travel but each with many followers.

Thus, the processing unit generates an aggregate score which may be referred to as “AGGR” herein. AGGR represents the relative ranking of uεAₜ. By looking at the subgraph induced by Aₜ on the original follower graph (U^{M}, E) only, a user u₁ may have a substantial number of followers in (U^{M}, E) but have very few followers who also belong to Aₜ. The number of followers in Aₜ may be more important than the total number of followers across the entire social graph, as the aim is to find users who can disseminate the message to potentially largest group of relevant users.

To capture these intuitions the processing unit models this scenario as a Hidden Markov Model (HMM), with each user in uεAₜ represented as a node in the hidden layer, and each topic in their aggregate signatures' represented as a node in the output layer. For users u, vεAₜ, if user u follows v, a directed edge is added in the Markov chain from u to v. Transition from one node to another takes place with equal probability. That is, if there are eᵤ edges out of node u, one of the edges is selected for transition with equal probability

$$\frac{1}{{e}_{u}} .$$

Since the Markov chain may have disconnected components, with a small pre-specified probability α a random jump takes place, and with probability 1−α one of the outgoing edges is selected.

Traversing the Markov chain, while at node u, having eᵤ outgoing edges, the probability of transition is computed as follows. If eᵤ is zero, the next node after transition is randomly picked from set Aₜ. Let |Aₜ| be the cardinality of the set Aₜ. If eᵤ is non zero, then the next node will be:

$$next ( u ) = ( \begin{matrix}pickrandom v ∈ {A}_{t} & withprob \frac{α}{\vert {A}_{t} \vert - {e}_{u}} \\ pickrandom v \text{\textbar} follows ( u , v ) & withprob \frac{1 - α}{{e}_{u}}\end{matrix}$$

This completes the construction of the Markov chain and emission probability for the topics is assigned at each node. The symbols being emitted from the HMM are dimensions of the topic signature. For example, if the topic signature of a user u is

$$topic ( u ) = {w}_{1} \cdot {\hat{s}}_{1} + {w}_{2} \cdot {\hat{s}}_{2} = \frac{1}{2} \hat{m} usic + \frac{1}{2} \hat{s} quash ,$$

then one of music or squash is emitted with equal probability when at the node in the HMM associated with this particular user u. Since the topic signatures are of unit length in [symbol] space, further normalizations are not needed to compute symbol emission probabilities. For a topic signature, topic(u)=w₁·ŝ₁+w₂·ŝ₂+ . . . +w_{N}·ŝ_{N}. The symbol sᵢ will be emitted with probability wᵢ. Since, w₀+w₁+ . . . +w_{N}=1, the sum of all probabilities will be 1.

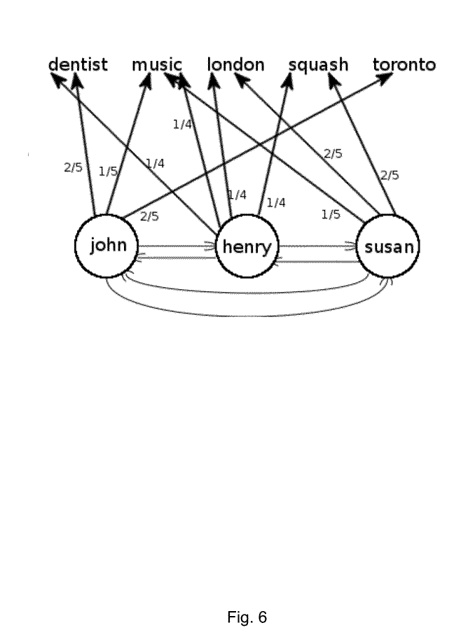

Continuing from the example used for the creation of the topic signature above and assuming each of the three users follow each other, the HMM as displayed in FIG. 6 is constructed. The hidden layer is constructed with three nodes, representing the three users. Transition edges are added, each with probability 1/2, such that Pr_{i!=j}(uᵢ|uⱼ)=0.5. As a result, the steady state distribution is observed to be Pr(john)=Pr(henry)=Pr(susan)=1/3 for the hidden layer. Marginalizing out user probability from Pr(topicsignature, user), the processing unit can compute the aggregate signature for the entire graph. For example,

$$Pr ( dentist ) = Pr ( dentist \vert john ) Pr ( john ) + Pr ( dentist \vert henry ) Pr ( henry ) = \frac{1}{3} \times \frac{2}{5} + \frac{1}{3} \times \frac{1}{4} = \frac{13}{60} , \\ and , \\ Pr ( toronto ) = Pr ( toronto \vert john ) Pr ( john ) = \frac{1}{3} \times \frac{2}{5} = \frac{2}{15} . \\ Similarly , Pr ( music ) = Pr ( london ) = Pr ( squash ) = \frac{13}{60} .$$

As a final check, performed by the processing unit, Pr(dentist)+Pr(music)+Pr(london)+Pr(squash)+Pr(toronto)=1. The resulting aggregate signature, therefore is

$$\frac{13}{60} \hat{d} entist + \frac{13}{60} \hat{m} usic + \frac{13}{60} \hat{l} ondon + \frac{13}{60} \hat{s} quash + \frac{2}{15} \hat{t} oronto .$$

The HMM has now been defined by the processing unit with a set of nodes, transition probabilities, and emission probabilities for symbols. The steady state probabilities for this HMM will allow the processing unit to compute the aggregate signature across the set of all users Aₜ. At steady state, assuming that the probability that a symbol sᵢ is seen is prob(sᵢ), then the aggregate signature will be, aggrsig(Aₜ)=prob(sᵢ)ŝᵢ+prob(s₂)ŝ₂+ . . . +prob(s_{N})ŝ_{N}, which is of unit length in [symbol] .

At steady state, assuming the probability that a symbol sᵢ is seen is prob(sᵢ), then the aggregate signature will be, aggrsig(Aₜ)=prob(sᵢ)ŝᵢ+prob(s₂)ŝ₂+ . . . +prob(s_{N})ŝ_{N}, which is of unit length in [symbol] . To compute the aggregate signature given the steady state distribution from the Twitter follower graph, the processing unit uses the definition of conditional probability. Observe that for topic s:

Pr(s)=ΣᵤPr(s,u)=ΣᵤPr(s|u)Pr(u) (1)

and since Pr(s|u) (the topic probability of a user u) and Pr(u) (the steady state probability of user u) are independent and known from the Markov chain and preprocessing, the processing unit proceeds to solve the HMM first by the hidden user layers, then the emission (topic) layer.

Marketers invest significant effort to change brand perception and association. A change in the audience of a brand could be organic over time, or it may be influenced by an event. For example, numerous marketing efforts attempt to reinvent or reposition brands in new target segments and change the way brands are perceived online or offline. An effort to make a brand more fashionable or trendy may be successful if the people taking about the brand online associate themselves with fashion and/or fashion trends. Thus, such changes, if one is able to identify them, may point to the success or failure of marketing efforts online. Identifying such changes in the conversation around events may further identify parties relevant to a political or academic subject and how insights evolve over time. In an exemplary scenario, the query “hurricane sandy” is considered. The processing unit conducts the search for one day time intervals for a 92 day long period from 1 Oct. 2012 to 31 Dec. 2012.

The processing unit may proceed to generate results as to how aggrsig(q, t) evolves over time for a long time range T consisting of D smaller time intervals, T={t1, t2, . . . tD}. The processing unit generates the aggregate signature for a given query q for each of the time intervals as: ASM(q, T)={aggrsig(q, t1), aggrsig(q, t2), . . . aggrsig(q, tD)}. The resulting matrix ASM(q, T) has N rows and D columns. The rows will each correspond to a topic dimension from S^{N}, and columns will each correspond to a time interval from T. This matrix is referred to as the aggregate signature matrix (ASM(q, T)) over time T for the query q.

Given an aggregate signature matrix ASM(q, T)={aggrsig(q, t1), aggrsig(q, tD)}, a pre specified k<D, and a function score that measures similarity of aggregate signatures, namely, score(aggrsig(q, tᵢ) . . . aggrsig(q, tⱼ))ε [symbol] ⁺ define a disjoint, continuous k partitioning of [1, 2, . . . , D] as Pₖ:={[b₁, e₁], [b₂, e₂], . . . , [bₖ, eₖ]} with b₁=1, eₖ=D, ∀ᵢbᵢ, eᵢε [symbol] , eᵢ≧bᵢ and ∀i<j, eᵢ=bⱼ−1 by solving for argmin_{P}_{ₖ}Σᵢ score(aggrsig(q, t_{b}_{ᵢ}), . . . , aggrsig(q, tₑ_{ᵢ})).

In embodiments, the processing unit may iterate over a few values of k and trace the value of the overall function score for each value of k. Points at which large discontinuities arise are typically good candidates for k.

The processing unit selects k groups of continuous days across the 92 day period for a pre-specified k. Each of these k date ranges will represent a distinct aspect of the event. For example, if k was 3, resulting date ranges could be expected to represent the pre-hurricane period, the period during the hurricane specifically as it passed over New York city, and the period post-hurricane.

Using the notations defined above, given the aggregate signature matrix ASM(q, T) and specified k<D, the processing unit partitions T into k continuous and disjoint intervals. The aim is to group similar time periods together, and this is formalized by defining a scoring function capturing similarity that is minimized. Once the scoring function has been chosen, the problem reduces to that of identifying the optimal partitioning.

The processing unit generates two scoring functions. The first function minimizes the total error represented as the sum of root mean square distance between the average aggregate signature of a collection of signatures and the aggregate signatures in the collection. The first measure, given a collection of aggregate signatures ASM={aggrsig(q, t1), aggrsig(q, t2), . . . aggrsig(q, tD)}, access the distance using the root mean square error:

$$score = {\sum }_{i} {‖ aggrsig ( q , {t}_{i} ) - ( \frac{{\sum }_{j} aggrsig ( q , {t}_{j} )}{D} ) ‖}_{2} .$$

The RMSE score increases as the distance between aggregate signatures increases, i.e., when the topics across {t1, t2, . . . , tD} are different, and decreases when the topics are the same. Therefore, with this score function intervals of time are singled out where the aggregate signatures are very similar to each other.

The second discretizes ASM(q, T) into an indicator matrix of 0 and 1, and measures similarity as the hamming distance across neighbouring aggregate signatures. A second error measure is proposed that involves the discretization of aggregate signatures. The value in each dimension of aggrsig(q, t₁), is between 0 and 1. The aggregate signature can be discretized by assigning each dimension the value of 0 or 1. There are many ways to discretize the signature; a statistically sound way is to assess the mean of all the values and assign a value as 1 if it is above some standard deviation of the mean and zero otherwise. Denote the discretized aggrsig(q, tᵢ) as agg [symbol] (q, tᵢ) and similarly, the discretized ASM(q, T) matrix as AS [symbol] T). With t1, t2, . . . , tD−1=T₁ and t2, . . . , tD=T₂, rewritten in the compact form: score=∥AS [symbol] T₂)−AS [symbol] T₁)∥_{F} using the Frobenius norm. ∥A∥_{F}=\sqrt{ΣᵢΣⱼ|Aᵢⱼ|²} where A is a matrix.

In further embodiments, given a function score that computes a distance between aggregate signatures of ASM(q, T), the following recurrence may be generated by the processing unit to measure the similarity of aggregate signatures. B_{j,k} is defined to be the best k partition score of the first j columns of ASM(q, T) using the given score function:

$${B}_{j , k} = {min}_{i < j} {B}_{i - k , k - 1} + score ( exp ( q , ti ) … exp ( q , tj ) ) . \qquad ( 2 )$$

The best K partition of ASM(q, T) for all K<D may be computed using Equation 2. Notice that it would take [symbol] (D^{D})score steps to solve the best K partition of ASM(q, T) for all K in a brute force way. Since there are D−1_{K-1} ways to produce k disjoint continuous intervals for [1, 2, . . . , D], the processing unit generates Σᵢ₌₁^{D} [symbol] (Dⁱ)= [symbol] (D^{D}).

Looking at the recurrence Equation 2 the processing unit may pre compute score(ASM(q, Ti) . . . ASM(q, Tj)) as it is independent from the recurrence. i←arg min_{i≦j} B_{i-1,k-1}+sco_{i,j} will take [symbol] (D) steps. When solving for the best K partition of ASM(q, T) for all K<D using dynamic programming, the runtime is dramatically reduced to [symbol] (D³). The space requirement can also be optimized by noting that in Equation 2, B_{j,k} depends only on the values from the previous iteration. Therefore, after an iteration is complete, the processing unit may discard the optimal interval partitioning and the optimal scoring from the last iteration, bringing the space requirement excluding the precomputed scores, down to [symbol] (D).

Continuing with the example above, for each day, the aggregate signature vector is computed based on everyone who is talking about the hurricane on that day i.e. who have posted a message containing the words hurricane and sandy). As time progresses, a natural evolution in the matrix ASM(q, T) for this query is expected. Hurricane Sandy first affected Caribbean and Bermuda on October 22nd, and Twitter users actively participating in the discussion topically associated with these regions. As days progressed, more American and subsequently global audience started discussing the hurricane. As the hurricane traveled from the southeast of the US (Florida, Virginia, Carolinas), to the mid-Atlantic region (Washington D.C., Maryland, New Jersey), and finally reached New York City, the group of users talking about the hurricane changed. In November, post-hurricane, the discussion shifted further to rebuilding efforts and those discussing were associated with politics. Intuitively it is evident that this 92 day time period can be partitioned into a discrete time periods which capture the evolution of this story namely tracing the geographical path of the storm (by observing the topics associated with those taking about it) and then capturing the political discussion centered in re-building efforts.

In embodiments, the processing unit may be configured to perform random sampling of data to speed up this computation without sacrificing quality. This effectively offers a good tradeoff between accuracy and speed.

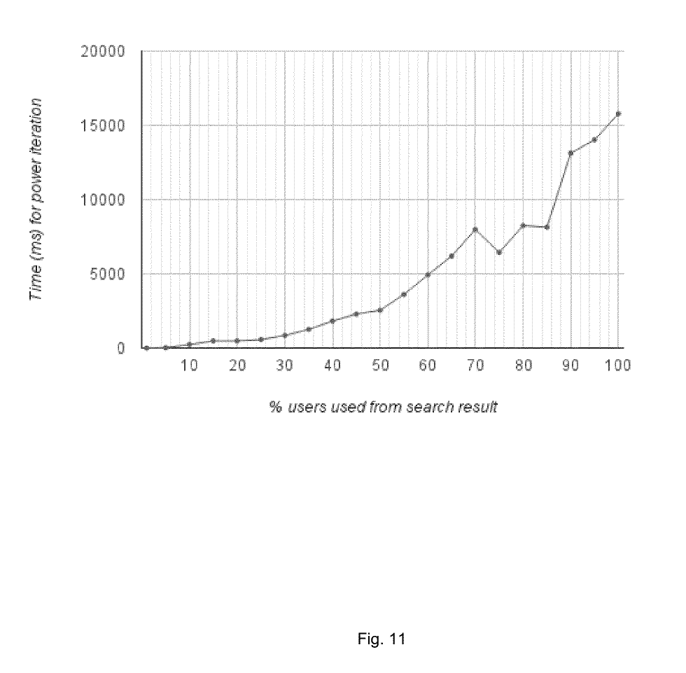

The system may be configured to process a subset of search results to reduce processing time for a query. Run time may be improved by using random sampling on the set Aₜ. Instead of constructing the HMM with all users in Aₜ, only a fraction, such as, for example, f≦1.0 may be randomly selected. Referring now to FIG. 11, processing time is shown as the fraction f varies.

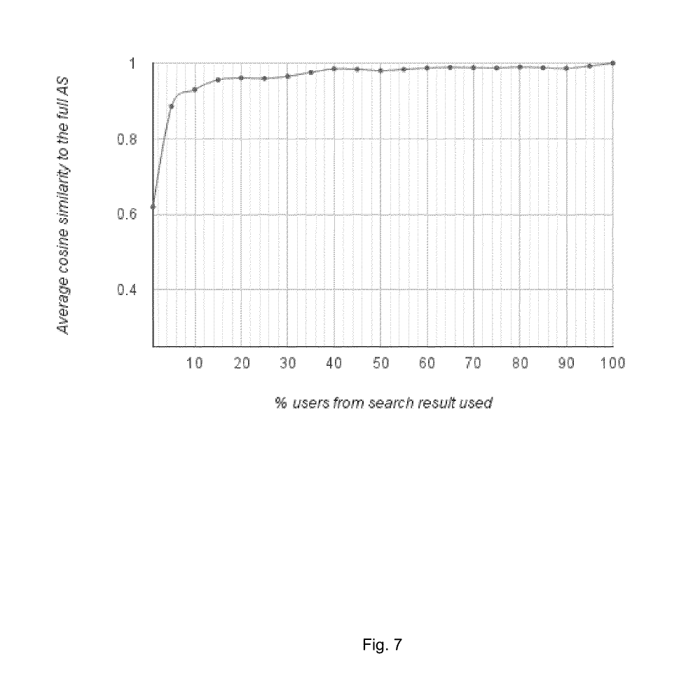

Referring now to FIG. 7, particular exemplary queries indicate that the use of 30% or more of the search results provides better than 90% (using cosine similarity) accuracy as compared to all results.

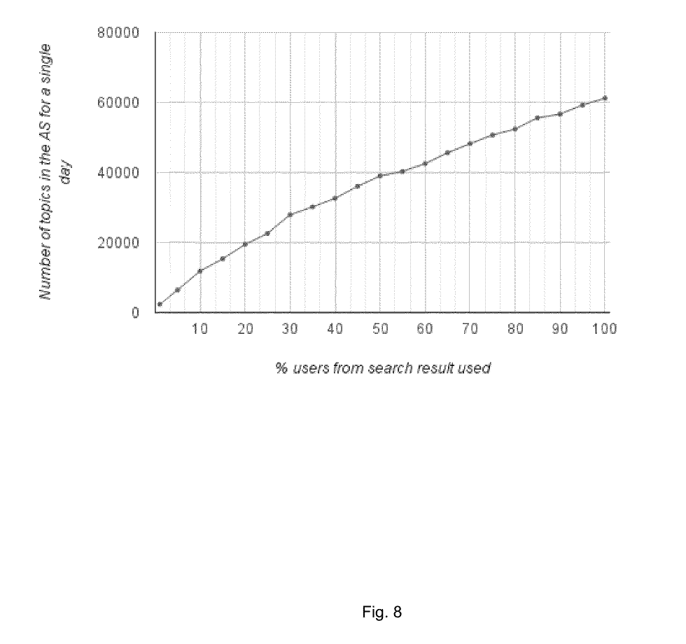

As the fraction f is reduced, the number of topics with non-zero weights may also decrease, as depicted in FIG. 8. Particular exemplary queries indicate that the use of 30% of the search results provide that the resulting AS has only half the number of topics with non-zero weights compared to AS′, however the topics not present are only those with small weight in AS′. Thus random sampling may speed up the AGGR processing considerably while producing similar results to AS′. Reduction in the number of topics with non-zero weights in AS further helps in reducing the run time and memory usage. While the specific results may not be representative of all queries, they indicate that the use of subsets of results can be made without substantial loss of accuracy, in cases.

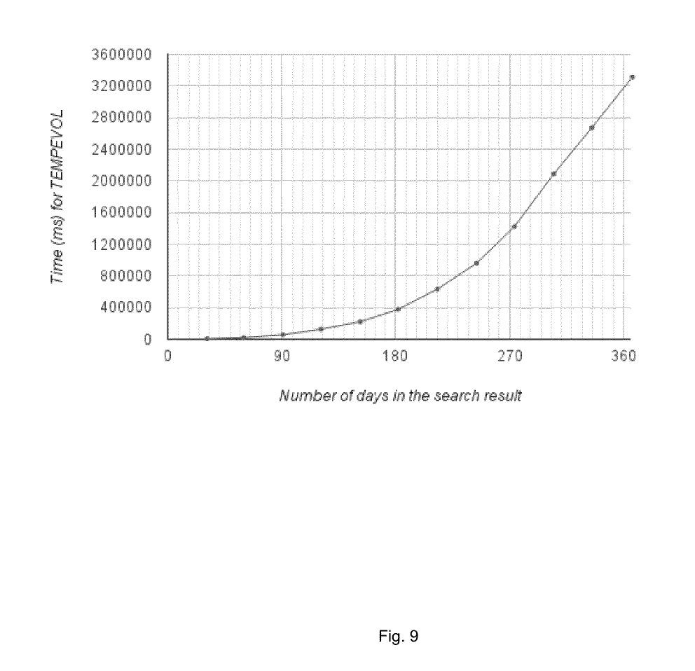

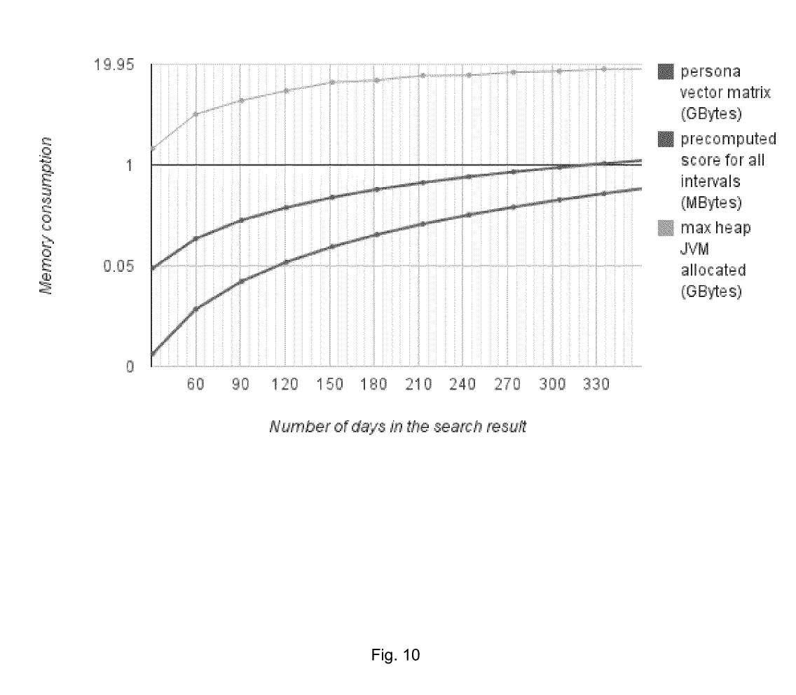

Referring now to FIG. 9, the running time of k as a function of the number of days of messages is considered. Particular exemplary queries indicate that given messages for one year, the run time, may be less than an hour. Further exemplary queries show that overall memory consumption scales linearly with the amount of data, as can be seen in FIG. 10.

Other applications may become apparent.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

1. A system for identifying one or more experts of a topic on a social network, the system comprising a server in communication over a network with a social network, the server comprising:
(a) a user interface unit configured to obtain a topical query representing the topic;
(b) an obtaining unit configured to obtain social network data from the social network, the social network data comprising one or more topical lists and a social graph representing user relationships in the social network, each topical list identifying one or more users;
(c) a tokenizing unit configured to:
(i) tokenize titles of the topical lists and lexically group the tokens into token groupings; and
(ii) tokenize the topical query to determine at least one token grouping to which the topical query corresponds; and
(d) a processing unit configured to:
(i) generate, for each user, a topic signature vector comprising topic signature vector elements corresponding to the token groupings for which the user is identified in the corresponding topical lists;
(ii) generate for each topic signature vector element an occurrence count representing the number of times each of the token groupings is identified for the user;
(iii) rank the users by their occurrence counts for the at least one token groupings corresponding to the topical query; and
(iv) return a selected set of the ranked users as experts in the topic.

2. The system of claim 1, wherein the system is further configured to identify one or more related topics of interest to users interested in the topical query, wherein the processing unit is further configured to: determine, for each expert of the topical query, other topics for which the expert is identified; and generate a ranked list of the determined other topics using a scoring function.

3. The system of claim 1, wherein the system is further configured to identify one or more related topics of interest to users interested in the topical query, wherein:
(a) the obtaining unit is further configured to obtain social network messages in the social network data;
(b) the tokenizing unit is configured to:
(i) tokenize the social network messages and lexically group the tokens into the token groupings; and
(c) the processing unit is configured to:
(i) determine a subset of the social network messages containing the topical query;
(ii) generate an aggregate signature comprising summing the topic signature vectors of the experts identified for the topical query;
(iii) determine other topics having a high occurrence count in the aggregate signature; and
(iv) return a selected set of the other topics as secondary topics.

4. The system of claim 3, wherein generating the aggregate signature further comprises determining the number of followers of the experts.

5. The system of claim 3, wherein generating the aggregate signature further comprises analyzing a social graph to determine reach.

6. The system of claim 2, wherein the processing unit is further configured to determine conversations the identified experts participate in and share.

7. The system of claim 1, wherein the processing unit is further configured to determine, for a given user, other users having similar interests.

8. The system of claim 3, wherein the processing unit is further configured to determine changes in conversations around events by determining changes in aggregate signatures over time.

9. The system of claim 8, wherein the changes in conversations enables an identification of users relevant to the conversations and insights into how conversations evolve over time.

10. The system of claim 8, wherein the processing unit is further configured to identify times at which the conversations change significantly.

11. A computer network implemented method for identifying one or more experts of a topic on a social network, the method comprising:
(a) obtaining a topical query representing the topic;
(b) obtaining social network data from the social network, the social network data comprising one or more topical lists and a social graph representing user relationships in the social network, each topical list identifying one or more users;
(c) tokenizing titles of the topical lists and lexically grouping the tokens into token groupings;
(d) tokenizing the topical query to determine at least one token grouping to which the topical query corresponds;
(e) generating, by a processing unit comprising one or more processors, for each user, a topic signature vector comprising topic signature vector elements corresponding to the token groupings for which the user is identified in the corresponding topical lists;
(f) generating, by the processing unit, for each topic signature vector element an occurrence count representing the number of times each of the token groupings is identified for the user;
(g) ranking the users by their occurrence counts for the at least one token groupings corresponding to the topical query; and
(h) returning a selected set of the ranked users as experts in the topic.

12. The method of claim 11, further comprising identifying one or more related topics of interest to users interested in the topical query, by determining, for each expert of the topical query, other topics for which the expert is identified; and generate a ranked list of the determined other topics using a scoring function.

13. The method of claim 11, further comprising identifying one or more related topics of interest to users interested in the topical query, by:
(a) obtaining social network messages in the social network data;
(b) tokenizing the social network messages and lexically group the tokens into the token groupings;
(c) determining a subset of the social network messages containing the topical query;
(d) generating an aggregate signature comprising summing the topic signature vectors of the experts identified for the topical query;
(e) determining other topics having a high occurrence count in the aggregate signature; and
(f) returning a selected set of the other topics as secondary topics.

14. The method of claim 13, wherein generating the aggregate signature further comprises determining the number of followers of the experts.

15. The method of claim 13, wherein generating the aggregate signature further comprises analyzing a social graph to determine reach.

16. The method of claim 12, further comprising determining conversations the identified experts participate in and share.

17. The method of claim 11, further comprising determining, for a given user, other users having similar interests.

18. The method of claim 13, further comprising determining changes in conversations around events by determining changes in aggregate signatures over time.

19. The method of claim 18, wherein the changes in conversations enables an identification of users relevant to the conversations and insights into how conversations evolve over time.

20. The method of claim 18, further comprising identifying times at which the conversations change significantly.
